(19) United States
(12) Patent Application Publication
(10) Pub. No.: US 2008/0266500 A1
(43) Pub. Date: Oct. 30, 2008

(54) LIQUID CRYSTAL DISPLAY DEVICE

(75) Inventor: Shigeaki NIMURA, Minami-ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 11/850,186

(22) Filed: Sep. 5, 2007

(30) Foreign Application Priority Data
Sep. 6, 2006 (JP) 241081-2006

(51) Int. Cl. G02F 1/13363

(52) U.S. Cl. 349/117

(57) ABSTRACT

A novel liquid crystal display device (LCD) is disclosed. The LCD comprises at least, a member of generating polarized light, a retardation member, a first polarizing element, a liquid-crystal cell and a second polarizing element, in this order, wherein the retardation member satisfies at least one condition of
(i) its in-plane retardation, Re, is from 10 nm to 3000 nm at a wavelength falling within a range from 400 to 780 nm, and
(ii) its thickness-direction retardation, Rth, is from 60 nm to 3000 nm at a wavelength falling within a range from 400 to 780 nm.

### CROSS-REFERENCE TO RELATED APPLICATIONS

This application claims benefit of priority under 35 U.S.C. 119 to Japanese Patent Application No. 2006-241081 filed Sep. 6, 2006, and the entire content of the application is incorporated herein by reference.

### BACKGROUND OF THE INVENTION

1. Field of the Invention

The present invention relates to a liquid-crystal display device in which a retardation member is disposed outside a polarizing element, for example, between the polarizing element and a brightness improving film therein; and more precisely, the invention relates to a liquid-crystal display device having a wide range of color timing and improved display characteristics.

2. Related Art

A liquid-crystal display device theoretically suffers from problems such as contrast and color shifts depending on the viewing direction, since it employs a liquid crystal cell in which liquid crystal is aligned in various directions, or it employs a polarizer. The contrast and color shifts depending on the viewing direction have been reduced significantly by improvement of liquid crystal cells such as VA-mode, IPS-mode or OCB-mode cells and by development of retardation films. However, with the recent tendency toward large-size liquid-crystal TV panels, further improvements are desired. In particular, the improvement of color change (color shift) is a significant problem; and the improvement is being promoted by optimization of the wavelength dispersion of the retardation film adjacent to the liquid-crystal cell in the device (Japanese Laid-Open Patent Publication No. 2006-89529).

Natural light outputted from a backlight in a liquid-crystal display device is directly led into a liquid-crystal cell in the device as it is still natural light. With the recent tendency toward large-size and high-resolution liquid-crystal display devices, the brightness of backlights is desired to increase, and various techniques of polarizing light from backlights are more and more employed. For example, there is known an example of disposing a brightness improving film, which is capable of improving brightness by polarizing natural light from a backlight, between a backlight and a polarizer.

Even in the case of employing such a brightness improving film, the color shift is observed, and various methods for reducing the color shift have been proposed. For example, in Japanese Laid-Open Patent Publication No. 2004-271846, it is proposed that a film having an extremely small retardation is disposed between a brightness improving film and a polarizer, for reducing color shift.

### SUMMARY OF THE INVENTION

An object of the present invention is to provide a liquid-crystal display device improved in color shift and displaying properties.

In one aspect, the present invention provides a liquid-crystal display device comprising at least, a member of generating polarized light, a retardation member, a first polarizing element, a liquid-crystal cell and a second polarizing element, in this order,

wherein the retardation member satisfies at least one condition of

(i) its in-plane retardation, Re, is from 10 nm to 3000 nm at a wavelength falling within a range from 400 to 780 nm, and

(ii) its thickness-direction retardation, Rth, is from 60 nm to 3000 nm at a wavelength falling within a range from 400 to 780 nm.

As embodiments of the invention, the liquid-crystal display device wherein the retardation member has a retardation, in a direction at a polar angel of 60° and an azimuthal angle of 45° with respect to an in-plane slow axis of the retardation member, falling with in a range from 50 nm to 1500 nm; the liquid-crystal display device wherein the retardation member satisfies at least one of the following formulae (A) and (B):

Re(λᵢ)/λᵢ>Re(λₖ)/λₖ, and λ_{i>λ}ₖ or λₖ>λᵢ (A)

Rth(λᵢ)/λᵢ>Rth(λₖ)/λₖ, and λᵢ>λₖ or λₖ>λᵢ (B)

wherein λᵢ and λₖ each mean a wavelength of from 400 to 780 nm; and Re(λₙ) and Rth(λ) each mean the in-plane retardation Re and the thickness-direction retardation Rth of the member, respectively, to the light having a wavelength of λₙ;

the liquid-crystal display device wherein the retardation member is disposed so that its in-plane slow axis is in parallel with a polarization direction of the member of generating polarized light; the liquid-crystal display device wherein the retardation member is directly adhered to the first polarizing element; and the liquid-crystal display device comprising a backlight on an outer side than the member of generating polarized light; are provided.

The retardation member may be a biaxial anisotropic plate.

The retardation member may comprise a layer formed of a composition comprising a liquid-crystal compound.

The retardation member may be a polymer film or comprise a polymer film such as a cellulose acylate film and a cyclic polyolefin film.

The member of generating polarized light may be a combination of a cholesteric liquid-crystal layer and a λ/4 plate.

The member of generating polarized light may be an anisotropic multi-layer thin film that transmits one linearly polarized light having a first vibration direction and reflects another linearly polarized light having a vibration direction perpendicular to the first vibration direction.

The member of generating polarized light may be an anisotropic scattering polarizing element.

### BRIEF DESCRIPTION OF THE DRAWINGS

FIG. 1 is a schematic cross-sectional view of one example of the liquid-crystal display device of the invention.

FIG. 2 is a schematic cross-sectional view of another example of the liquid-crystal display device of the invention.

In the drawings, the reference numerals have the following meanings:
10, 10′ Liquid-Crystal Display Device
12 Polarized Light Generating Member
14 Retardation Film (retardation member)
16 Polarizing Element (first polarizing element)
18 Liquid-Crystal Cell
20 Polarizing Element (second polarizing element)
22a, 22b Retardation Film

### DETAILED DESCRIPTION OF THE INVENTION

The invention is described in detail hereinunder. In this description, the numerical range expressed by the wording “a number to another number” means the range that falls between the former number indicating the lowermost limit of the range and the latter number indicating the uppermost limit thereof.

The invention relates to a liquid-crystal display device comprising at least, a polarized light generating member, a retardation member, a first polarizing element, a liquid-crystal cell, and a second polarizing element, in this order, in which the retardation member satisfies predetermined optical characteristics. A member, which is used in a liquid crystal display as a so-called brightness improving film, can be employed in the invention as a polarized light generating member. For example, regarding a high-brightness polarizer having thereon a brightness improving film capable of transmitting one polarized light but reflecting the other, light passing through the brightness improving film may be converted into a nearly linearly polarized light, and this enters a polarizing element. In terms of reducing color shift, it is preferred that linearly polarized light outputted from the brightness improving film enters the polarizing element without changing its polarization state. Therefore, in a polarizer having such a brightness improving film thereon, as a protective film, which is usually disposed on the surface of a polarizing element and which is disposed between the polarizing element and the brightness improving film, a film having an in-plane retardation Re of nearly 0 nm is usually employed, in order that linearly polarized light outputted from the brightness improving film can pass though the protective film without changing its polarization state.

However, as a result of the inventor's assiduous studies, they found that, when a retardation member having predetermined optical characteristics, or that is, a specific retardation member of which the in-plane retardation Re and/or the thickness-direction retardation Rth are not 0 nm but fall within a predetermined range, is disposed between the brightness improving film and the polarizing element, then the color shift may be reduced, and as a result, the display characteristics of the device may be improved.

Specifically, according to the invention, polarized light outputted from a member such as a brightness improving film, which is disposed outside a polarizing element and which may polarize a part or all of natural light, is led into the polarizing element via a retardation member. Since the retardation member satisfies predetermined optical characteristics, it can generate birefringence interference (see “Koubunshi Sozai no Henkou Kenbikyou Nyumon (Introduction to Polarization Microscope of Polymer Material) published by AGUNE GIJUTSU CENTER). And, so, it is possible to control the color tone of light to enter the liquid-crystal cell by birefringence interface generated from the retardation member. For example, light naturally rich in blue may be modified into reddish light, and light naturally rich in red may be modified into bluish light, whereby the viewers may recognize the light as neutral color light.

In this way, according to the invention, the color tone can be controlled by the retardation member disposed outside a polarizing element. The optical characteristics of the retardation member can be adjusted separately from adjusting the optical characteristics of any other retardation members (including an optical retardation member that is also provided as a polarizer-protective film) generally disposed between a liquid-crystal cell and a polarizing element for optical compensation for the liquid-crystal cell. And, so, according to the invention, it is possible to easily control the color tone. Further, because of the advantage that the optical characteristics may be independently controlled, the number of the retardation films to be disposed between the liquid-crystal cell and the polarizing element may be reduced, and therefore, the invention may also contribute to reduction in the thickness of liquid-crystal panels.

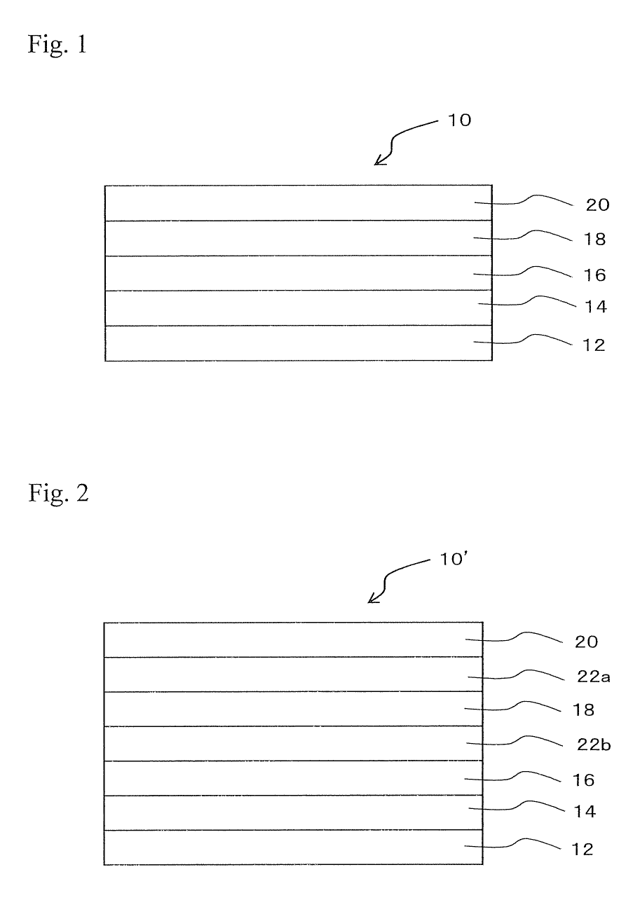

The invention is described below with reference to the drawings. FIG. 1 is a schematic cross-sectional view of one example of the liquid-crystal display device of the invention; and FIG. 2 is a schematic cross-sectional view of another example of the liquid-crystal display device of the invention.

The liquid-crystal display device 10 in FIG. 1 comprises a member of generating polarized light (hereinafter referred to as “polarized light generating member”) 12, a retardation film 14, a first polarizing element 16, a liquid-crystal cell 18, and a second polarizing element 20, disposed in this order. A light source such as backlight is disposed outside the polarized light generating member 12, and viewers see the images of light outputted from the polarizing element 20, as a display image. As described in the above, a part or all of natural light outputted from the backlight or the like is converted into a polarized light by going through the polarized light generating member 12, and is then led into the retardation film 14. The thus-entered light is given a predetermined retardation by the retardation film 14. For example, when the image is bluish owing to the birefringence of the liquid-crystal cell 20, then light may be given retardation by going thorough the retardation film 14 so that light could be shifted to a reddish one; but when the image is reddish, then light may be given retardation by going through the retardation film 14 so that light could be shifted to a bluish one. As a result, the images to be seen by viewers may have a neutral color tone.

The liquid-crystal display device 10′ in FIG. 2 differs from the liquid-crystal display device 10 in FIG. 1, in that the former comprises retardation films 22a and 22b which are disposed to sandwich the liquid-crystal cell 18 therebetween. The retardation films 22a and 22b optically compensate the liquid-crystal cell, thereby contributing to widening the viewing angle. Their functions are not specifically defined; for example, they may inhibit gradation reversal in observation in the oblique direction and inhibit light leakage in a black state, or they may reduce color shift in observation in the oblique direction. In the liquid-crystal display device 10′ in FIG. 2, independently of the function of the retardation film 14 that acts for color control to neutral tone, the optical characteristics of the retardation films 22a and 22b are controlled to thereby improve the other viewing angle characteristics of the device, for example, to reduce the light leakage in the oblique direction and to reduce color shift in observation in the oblique direction. Depending on the mode of the liquid-crystal cell 18, the retardation films 22a and 22b may be selected from any known optical compensatory films. Depending on the mode of the liquid-crystal cell 18 or on the optical characteristics of the retardation film used, the retardation film may be disposed only between one polarizer and the liquid-crystal cell.

In the liquid-crystal display devices 10 and 10′, the first polarizing element 12 and the second polarizing element 20 are generally disposed so that their polarization axes are perpendicular to each other. Though not shown in the drawings, these polarizing elements may have a protective film on their surface. However, it is desirable that the retardation film 14 may act also as the surface protective film on the light source side of the first polarizing element 12, since the body of the liquid-crystal display device having the structure may be thinned. In this embodiment, it is desirable that the retardation film 14 comprises a polymer film such as a cellulose acylate film capable of protecting the polarizing element.

In the liquid-crystal display devices 10 and 10′, it is desirable that the polarization direction of the polarized light generating member 12 and the in-plane slow axis of the retardation film 14 are in parallel to each other.

Various members which can be employed in the liquid-crystal display device of the invention are described in more detail hereinunder.

### [Retardation Member]

In FIG. 1 and FIG. 2, the retardation film 14 is the retardation member of the invention; and its Re is from 10 nm to 3000 nm and/or its Rth is from 60 nm to 3000 nm for light having a wavelength ranging falling within a range of from 400 to 780 nm. Preferably, its Re is from 100 to 500 nm and/or its Rth is from 200 to 800 nm; more preferably its Re is from 150 to 300 nm and/or its Rth is from 400 to 600 nm. When Re and Rth of the member are less than the range, then it is unfavorable since the effect of the member for color shift reduction may be small; but when Re and Rth thereof are more than the range, then it is also unfavorable since the viewing angle-dependent color shift of the device may be large.

The retardation member, shown as the retardation film 14 in FIG. 1 and FIG. 2, has a retardation in a direction at a polar angel of 60° and an azimuthal angle of 45° with respect to its in-plane slow axis, referred to as “effective Re”, falling with in a range from 50 nm to 1500 nm. The effective Re of the retardation member preferably ranges from 50 nm to 1000 nm, and more preferably from 50 nm to 700 nm.

Further, it is preferable that the wavelength dependency of the optical characteristics of the retardation member satisfies at least one of the following formulae (A) and (B).

Re(λᵢ)/λᵢ>Re(λₖ)/λₖ, and λᵢ>λₖ or λₖ>λᵢ (A)

Rth(λᵢ)/λᵢ>Rth(λₖ)/λₖ, and λᵢ>λₖ or λₖ>λᵢ (B)

In these, λ₁ and λₖ each mean a wavelength of from 400 to 780 nm; and Re(λₙ) and Rth(λₙ) each mean the in-plane retardation Re and the thickness-direction retardation Rth of the member, respectively, to the light having a wavelength of λₙ. The retardation member satisfying at least one of the formulae (A) and (B) can control the color tone without depending on the wavelength of light.

According to the invention, the optical anisotropy of the retardation member in the invention may be the same as that of a c-plate or a-plate, or may be biaxial or hybrid anisotropy, but is preferably the same as that of a c-plate or a-plate or is biaxial, more preferably biaxial. In a case where the retardation member has an in-plane slow axis as well as an a-plate, c-plate or biaxial member, then it is desirable that the in-plane slow axis is in parallel to the polarization direction of the adjacent polarized light generating member in terms of reducing color shift.

The constitution and the material of the retardation member in the invention are not specifically defined. Preferably, the member is in the form of a film, as it may reduce the size of the liquid-crystal display device comprising it. Preferably, the retardation member is selected from a polymer film, for example, selected from polyester-type polymer films and polycarbonate-type polymer films. Above all, the retardation member is more preferably selected from cellulose acylate-type polymer films and cycloolefin-type polymer films in terms of the producibility of the member. In addition, any films formed by curing a polymerizable composition containing a liquid-crystal compound are also favorable for the member in terms of the producibility of the member.

### Polycarbonate:

Not specifically defined, the polycarbonate usable in forming the retardation member may be selected from any polycarbonates capable of making the retardation member having desired characteristics. In general, polycarbonate is a generic term for a polymer in which the main chain segments bond to each other via a carbonic bond therebetween through polycondensation, in a broad sense of the word; and in general, the term “polycarbonate” is used as a term indicating a polymer obtained through polycondensation of phosgene and diphenyl carbonate. In general, an aromatic polycarbonate having a repetitive unit of 2,2-bis(4-hydroxyphenyl)propane (generally referred to as bisphenol A) as the bisphenol component thereof is favorably used for it, from the viewpoint of the economical aspect and the physical properties thereof. In addition, various bisphenol derivatives may be selected and used to constitute the polycarbonate copolymers for use herein.

In addition to bisphenol A, the copolymerization component includes bis(4-hydroxyphenyl)methane, 1,1-bis(4-hydroxyphenyl)cyclohexane, 9,9-bis(4-hydroxyphenyl)fluorenone, 1,1-bis(4-hydroxyphenyl)-3,3,5-trimethylcyclohexane, 2,2-bis(4-hydroxy-3-methylphenyl)propane, 2,2-bis(4-hydroxyphenyl)-2-phenylethane, 2,2-bis(4-hydroxyphenyl)-1,1,1,3,3,3-hexafluoropropane, bis(4-hydroxyphenyl)diphenylmethane, bis(4-hydroxyphenyl) sulfide, bis(4-hydroxyphenyl) sulfone. Those comonomers in which the hydrogen atoms of the phenyl group are partially substituted with a methyl group and a halogen atom may also within the scope of the copolymerization component.

A polyester carbonate partially containing a terephthalic acid and/or isophthalic acid component is also usable herein. Using these constitutive units as a part of the constitutive component of the polycarbonate that comprises bisphenol A may improve the properties of the polycarbonate, for example, the heat resistance and the solubility thereof, and the copolymers of the type are also effective in the invention.

The molecular weight, the viscosity-average molecular weight, of the polycarbonate for use in forming the retardation member, calculated based on the viscosity thereof measured in a methylene chloride solution having a polymer concentration of 0.7 g/dL, at 20° C., is preferably from 10,000 to 200,000, more preferably from 20,000 to 120,000. When a polymer having a viscosity-average molecular weight of smaller than 10,000 is used, then it is unfavorable since the mechanical strength of the film formed may be low; and when a polymer having a high molecular weight of more than 200,000 is used, then it is also unfavorable since the dope viscosity thereof in a solvent-casting method may be too high and the handlability of the polymer may be problematic.

In case where the film is formed according to a solvent-casting method, used is a dope prepared by dissolving a polycarbonate in an organic solvent. The solvent to be used in preparing the dope is preferably a mixed solvent that comprises a solvent of essentially methylene chloride, a solvent of essentially 1,3-dioxolane, and xylene. P-xylene, o-xylene and m-xylene may be separately used for xylene for the mixed solvent, or they may be mixed for it. The blend ratio of xylene in the mixed solvent may be from 0.1 to 2.0% by mass of the dope, more preferably from 1.0 to 1.3% by mass. When the blend ratio of xylene to the dope is more than 2.0% by mass, then it is unfavorable since the dope may be whitened. When the blend ratio is less than 0.1% by mass, it is also unfavorable since the solvent may be ineffective for unifying the optical properties of the cast film in monoaxially stretching it.

One example of a method of preparing the polycarbonate dope, for example, having a polymer concentration of 20% comprises dissolving a polycarbonate in methylene chloride, in which methylene chloride is previously mixed with a small amount of xylene, and a polycarbonate is put into it and stirred and dissolved at room temperature. In this case, the amount of xylene to be added to the dope is controlled to be from 0.1 to 2.0% by mass of the dope formed.

Next, the obtained dope is cast onto a steel belt or drum or on a substrate film (generally a biaxially-oriented film of polyester) to form a film thereon, according to a known method; and while semi-dried, it is peeled away to obtain a solvent-containing film. Next, this is dried in a pin tenter drier or roll-hanging drier, whereby the residual solvent amount in the film may be from 0.5 to 2.0% by mass, more preferably from 1.0 to 1.5% by mass. When the residual solvent amount is less than 0.5% or more than 2.0%, then it is unfavorable since the optical characteristics could not be effectively unified in monoaxially stretching the film. The residual solvent as referred to herein contains methylene chloride and xylene, or 1,3-dioxolane and xylene. When dried, methylene chloride and 1,3-dioxolane may be more readily evaporated away than xylene, and the film dried to have a residual content of at most 2% by mass may contain a larger amount of xylene. Owing to the effect of the remaining xylene, the film may be uniformly stretched and the optical characteristics of the resulting film may be unified.

Next, the solvent-containing film obtained in the above is stretched. The stretching may be effected in any known method, for example, according to a method where the film is stretched between two pairs of rolls having a different peripheral speed, or according to a method where the film is stretched in a air-floating drier under heat and tension applied thereto. In this case, the stretching temperature is to fall within a range of from (Tg−5)° C. and (Tg+15)° C. The draw ration in stretching may be determined, depending on the desired retardation value. When the stretching temperature is (Tg−5)° C. or higher, then a film having desired optical characteristics may be produced stably with no stretching mottles therein, and the polymer chain orientation relaxation in the stretched film may be satisfactory. When the stretching temperature is (Tg+15)° C. or lower, then it is also favorable since the film may be stretched uniformly, and similarly, a stretched film having desired optical characteristics may be produced stably. More preferably, the stretching temperature is within a range of from Tg to (Tg+15)° C. It is desirable that the stretching temperature is a relatively higher temperature within the above temperature range for the purpose of minimizing the residual solvent amount in the stretched film.

The monoaxial stretching may be effected continuously in the process, or may be effected in a batch mode where the solvent-containing film is once wound up and then stretched.

### Polyester:

The polyester for use in forming the retardation member in the invention is not specifically defined in point of its structure. Concretely, examples of the polyester include polyethylene terephthalate, polyethylene naphthalate, polybutylene terephthalate, polybutylene naphthalate. Of those, especially preferred is polyethylene terephthalate from the viewpoint of the cost and the mechanical strength thereof. In particular, preferred is a polymer obtained through polycondensation of an aromatic dicarboxylic acid and an aliphatic glycol.

The aromatic dicarboxylic acid includes isophthalic acid and 2,6-naphthalenedicarboxylic acid, in addition to terephthalic acid, and their lower alkyl esters (anhydrides, derivatives capable of forming esters such as lower alkyl esters) may also be used.

The aliphatic glycol includes ethylene glycol, propylene glycol, butanediol, neopentyl glycol, 1,4-cyclohexanedimethanol, diethylene glycol, and p-xylylene glycol.

Of those, preferred is a polymer comprising, as the essential ingredient thereof, polyethylene terephthalate obtained through reaction of terephthalic acid and ethylene glycol. The polymer comprising polyethylene terephthalate as the essential ingredient thereof means a copolymer having polyethylene terephthalate repetitive units in an amount of at least 80 mol %, and also means a polymer mixture prepared by blending polyethylene terephthalate in a ratio of at least 80% by mass.

The polyester for use as the retardation member may contain a sulfonic acid group. The polyester containing a sulfonic acid group may be produced, using an aromatic dicarboxylic acid having a group selected from sulfonic acid and its salt, as a monomer. Examples of the aromatic dicarboxylic acid of the type include 5-sodium sulfoisophthalate, 2-sodium sulfoisophthalate, 4-sodium sulfoisophthalate, 4-sodium sulfo-2,6-naphthalenedicarboxylate, and their ester-forming derivatives, as well as compounds derived from them by substituting sodium therein with any other metal (e.g., potassium, lithium). In addition, compounds derived from glycol by introducing a group selected from sulfonic acid and its salt thereinto may also be used. However, it is desirable that the sulfonic acid group-having polyester is produced by the use of the above-mentioned aromatic dicarboxylic acid containing a sulfonic acid group or its salt, as a monomer. The copolymerization ratio of the aromatic dicarboxylic acid component having a sulfonic acid group or its salt is not specifically defined. For stable stretching and for obtaining a film having good mechanical strength and good driability, it is desirable that the ratio of the aromatic dicarboxylic acid component containing a sulfonic acid group or its salt is from 1 mol % to 10 mol % of all the aromatic dicarboxylic acid component to be used in forming the film.

The polyester for use in forming the phase retardation member may be copolymerized with any other component or may be blended with any other polymer, not interfering with the effect of the invention.

The other aromatic dicarboxylic acid and its derivatives than the above usable herein include aromatic dicarboxylic acids and their lower alkyl esters (anhydrides, derivatives capable of forming esters such as lower alkyl esters), for example, 2,7-naphthalenedicarboxylic acid, 1,5-naphthalenedicarboxylic acid, diphenyldicarloxylic acid, diphenylether dicarboxylic acid. In producing the member, further usable are alicyclic dicarboxylic acids and their derivatives (anhydrides, derivatives capable of forming esters such as lower alkyl esters), for example, cyclopropanedicarboxylic acid, cyclobutanedicarboxylic acid, hexahydroterephthalic acid; and aliphatic dicarboxylic acids and their derivatives (anhydrides, derivatives capable of forming esters such as lower alkyl esters), for example, adipic acid, succinic acid, oxalic acid, azelaic acid, sebacic acid, dimer acid, in an amount of at most 10 mol % of all the dicarboxylic acid component.

Glycol usable in producing the polyester includes trimethylene glycol, triethylene glycol, tetramethylene glycol, hexamethylene glycol, neopentyl glycol, bisphenol A, p,p′-dihydroxyphenyl sulfone, 1,4-bis(β-hydroxyethoxyphenyl)propane, polyalkylene (e.g., ethylene, propylene) glycol, and p-phenylenebis(dimethylolcyclohexane), in addition to ethylene glycol and other glycols mentioned above. These may be used in an amount of at most 10 mol % of all the glycol component used.

The polyester for use in forming the retardation member may be modified, for example, its terminal hydroxyl group and/or carboxyl group may be blocked with a monofunctional compound such as benzoic acid, benzoylbenzoic acid, benzyloxybenzoic acid or methoxypolyalkylene glycol, or the polyester may be modified with a minor amount of a trifunctional or tetrafunctional ester-forming compound such as glycerin or pentaerythritol within a range within which a substantially linear copolymer may be obtained.

In producing the polyester, it may be copolymerized with a bisphenol-type compound or a naphthalene or cyclohexane ring-having compound for the purpose of improving the heat resistance of the film.

Not specifically defined, the polyester film for use as the retardation member may be produced in various known methods. Especially preferably, the film is produced according to a biaxial film-stretching method. One example of the method is described in detail hereinunder. In the following description, “machine direction (MD)” means a film-forming direction (lengthwise direction); and “cross direction (CD)” means a direction perpendicular to the film-forming direction.

First, a starting polyester is shaped into pellets, and dried with hot air or in vacuum, then melt-extruded through a T-die as a sheet, and this is airtightly stuck to a cooling drum through electrostatic application, and then cooled and solidified to obtain an unstretched film. Next, the obtained unstretched film is heated within a temperature range of from the glass transition temperature (Tg) of the polyester to (Tg+100)° C., using a heating device such as a group of plural rolls and/or an IR heater, whereby it is MD-stretched in one stage or in multiple stages.

Next, the MD-stretched polyester film, obtained in the manner as above, is CD-stretched within a temperature range of from Tg to Tin (melting point), and then thermally fixed.

Thermally-fixed film is cooled generally to Tg, and the clipped part of both edges of the film is trimmed away, and then the film is wound up. In this stage, it is desirable that the film is subjected to relaxation by 0.1 to 10% in the cross direction and/or the machine direction within a temperature range of from the final thermal-fixing temperature to Tg. The method for relaxation is not specifically defined, and the relaxation may be effected in any known method. It is desirable that the film is cooled successively in plural temperature ranges for the relaxation treatment, from the viewpoint of improving the dimensional stability of the film.

The biaxially-stretched polyester film may have excellent mechanical strength since the molecular orientation therein is fully controlled. Not specifically defined, the draw ratio in stretching in one direction is preferably from 1.5 to 7 times, more preferably from 2 to 5 times or so. In particular, the film biaxially stretched in a draw ratio in one direction of from 2 to 5 times or so is favorable as having excellent mechanical strength since the molecular orientation is more effectively controlled. When the draw ratio in stretching is less than 1.5 times, then the mechanical strength of the stretched film may be insufficient, but on the other hand, when the draw ratio is more than 7 times, then the stretched film may hardly have a uniform thickness.

The optimum condition for thermal fixation, cooling and relaxation may differ, depending on the polyester to constitute the film, and therefore, the condition for the treatment may be suitably determined in order that the stretched film obtained after the treatment may have desirable properties.

Since polyester films may well express Re and Rth, they may be thinned, and they are therefore favorable for applications required to have a thin-wall body.

### Cellulose Acylate:

Not specifically defined, the cellulose acylate for use in forming the retardation member may be any cellulose acylate film produced in ordinary methods. Regarding a method for producing cellulose acylate, its basic principle is described in Wood Chemistry by Migita et al., pp. 180-190 (Kyoritsu Publishing, 1968). One typical method for producing cellulose acylate is a liquid-phase acylation method with carboxylic acid anhydride-carboxylic acid-sulfuric acid catalyst. Concretely, a starting material for cellulose such as cotton linter or woody pulp is pretreated with a suitable amount of acetic acid, and then put into a previously-cooled carboxylation mixture for esterification to produce a complete cellulose acylate (in which the overall degree of acyl substitution at the 2-, 3- and 6-positions is nearly 3.00). The carboxylation mixture generally includes acetic acid serving as a solvent, a carboxylic acid anhydride serving as an esterifying agent, and sulfuric acid serving as a catalyst. In general, the amount of the carboxylic acid anhydride to be used in the process is stoichiometrically excessive over the overall amount of water existing in the cellulose that reacts with the anhydride and that in the system. Next, after the acylation, an aqueous solution of a neutralizing agent (e.g., carbonate, acetate or oxide of calcium, magnesium, iron, aluminium or zinc) is added to the system for hydrolyzing the excessive carboxylic acid anhydride still remaining in the system and for partially neutralizing the esterification catalyst therein. Next, the resulting complete cellulose acylate is saponified and ripened by keeping it at 50 to 90° C. in the presence of a small amount of an acylation catalyst (generally, sulfuric acid remaining in the system), thereby converting it into a cellulose acylate having a desired degree of acyl substitution and a desired degree of polymerization. At the time when the desired cellulose acylate is obtained, the catalyst still remaining in the system is completely neutralized with the above-mentioned neutralizing agent, or the catalyst therein is not neutralized, and the cellulose acylate solution is put into water or diluted acetic acid (or water or diluted acetic acid is put into the cellulose acylate solution) to thereby separate the cellulose acylate through coagulation flocculation, and thereafter this is washed and stabilized to obtain the intended product, cellulose acylate.

Cellulose as the starting material for cellulose acylate includes cotton linter and woody pulp (broad-leaved tree pulp, coniferous tree pulp), and cellulose acylate obtained from any of such starting cellulose materials may be used in the invention. As the case may be the materials may be mixed for use herein. The starting cellulose materials are described in detail, for example, in Marusawa & Uda's “Plastic Material Lecture (17), Cellulosic Resin” (by Nikkan Kogyo Shinbun, 1970), and in Hatsumei Kyokai Disclosure Bulletin No. 2001-1745, pp. 7-8. Cellulose materials described in these may be used for the cellulose acylate film for the invention with no specific limitation.

Preferably, the cellulose acylate for use in forming the retardation member has a viscosity-average degree of polymerization of from 180 to 700, more preferably from 180 to 550, even more preferably from 180 to 400, still more preferably from 180 to 350. When the degree of polymerization of the polymer is too high, then the viscosity of the cellulose acylate dope may be high, and if so, film formation by casting it may be difficult. When the degree of polymerization of the polymer is too low, the strength of the film formed is degreased. The viscosity-average degree of polymerization may be determined according to an Uda et al's limiting viscosity method (Kazuo Uda, Hideo Saito; the Journal of the Society of Fiber Science and Technology of Japan, Vol. 18, No. 1, pp. 105-120, 1962). This is described in detail in Japanese Laid-Open Patent Publication No. 9-95538.

Preferably, the molecular weight distribution of the cellulose acylate is as narrow as possible. Concretely, the polydispersiveness index of the polymer, Mw/Mn (Mw means a mass-average molecular weight, and Mn indicates a number-average molecular weight), as evaluated through gel permeation chromatography, is preferably smaller, and more concretely, it is preferably from 1.0 to 3.0, even more preferably from 1.0 to 2.0, still more preferably from 1.0 to 1.6.

Not specifically defined, the acyl group having from 2 to 22 carbon atoms, as selected from acetic acid and/or fatty acid having from 3 to 22 carbon atoms to be a substituent for the hydroxyl group in cellulose, may be an aliphatic acyl group or an aromatic acyl group, and may be a single group or a mixture of two or more different groups. For example, it includes alkylcarbonyl esters, alkenylcarbonyl esters, aromatic carbonyl esters and aromatic alkylcarbonyl esters of cellulose, and these may have a further substituted group. The preferred acyl groups include acetyl, propionyl, butanoyl, heptanoyl, hexanoyl, octanoyl, decanoyl, dodecanoyl, tridecanoyl, tetradecanoyl, hexadecanoyl, octadecanoyl, iso-butanoyl, t-butanoyl, cyclohexanecarbonyl, oleoyl, benzoyl, naphthylcarbonyl and cinnamoyl groups. Of those, preferred are acetyl, propionyl, butanoyl, dodecanoyl, octadecanoyl, t-butanoyl, oleoyl, benzoyl, naphthylcarbonyl and cinnamoyl groups; and more preferred are acetyl, propionyl and butanoyl groups.

The cellulose acylate film for use as the retardation member may be a film produced according to a solvent-casting process. In the solvent-casting process, used is a cellulose acylate dope prepared by dissolving a cellulose acylate in an organic solvent. Preferably, the cellulose acylate concentration in the dope is from 10 to 30% by mass, more preferably from 13 to 27% by mass, even more preferably from 15 to 25% by mass. For preparing the cellulose acylate dope having a concentration falling within the range, cellulose acylate may be dissolved in a solvent to have a predetermined concentration in the stage of preparing the dope; or a cellulose acylate dope having a low concentration (e.g., 9 to 14% by weight) may be first prepared and it may be concentrated in a later concentration step to be a high-concentration dope. Apart from these, a high-concentration cellulose acylate dope may be first prepared, and various additives may be added thereto to give a low-concentration cellulose acylate dope having a predetermined concentration. Any of these methods may be employed herein with no problem

### Cyclic Polyolefin:

The cyclic polyolefin as referred to herein means a polymer having a cyclic polyolefin structure. In the invention, the cyclic polyolefin may be referred to as a cyclic polyolefin.

Examples of the cyclic polyolefin for use in forming the retardation member include (1) norbornene polymer, (2) monocyclic olefin polymer, (3) cyclic conjugated diene polymer, (4) vinylic alicyclic hydrocarbon polymer, and hydrides of (1) to (4). Of those, preferred are an addition (co)polymerization cyclic polyolefin containing at least one repetitive unit of the following general formula (II), and an addition (co)polymerization cyclic polyolefin optionally further containing at least one repetitive unit of the following general formula (I). Also preferred is a ring-cleavage (co)polymer containing at least one cyclic repetitive unit of the following general formula (III).

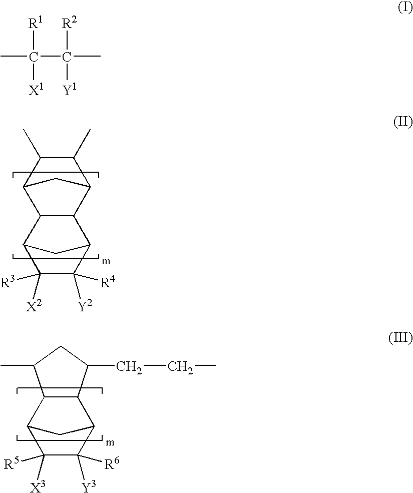

In these formulae, In indicates an integer of from 0 to 4. R¹ to R⁶ each represent a hydrogen atom, or a hydrocarbon group having from 1 to 10 carbon atoms; X¹ to X³ and Y¹ to Y³ each represent a hydrogen atom, a hydrocarbon group having from 1 to 10 carbon atoms, a halogen atom, a halogen atom-substituted hydrocarbon group having from to 10 carbon atoms, —(CH₂)ₙCOOR¹¹, —(CH₂)ₙOCOR¹², —(CH₂)ₙNCO, —(CH₂)ₙNO₂, —(CH₂)ₙCN, —(CH₂)ₙCONR³R⁴, —(CH₂)ₙNR¹³R¹⁴, —(CH₂)ₙOZ, —(CH₂)ₙW, or X¹ and Y¹, or X² and Y², or X³ and Y³ may form (—CO)₂O or (—CO)₂NR¹⁵. R¹¹, R², R¹³, R¹⁴ and R¹⁵ each represent a hydrogen atom, or a hydrocarbon group having from 1 to 20 carbon atoms; Z represents a hydrocarbon group, or a halogen-substituted hydrocarbon group; W represents SiR¹⁶ₚD₃₋ₚ (R¹⁶ represents a hydrocarbon group having from 1 to 10 carbon atoms; D represents a halogen atom, —OCOR¹⁶ or —OR¹⁶; p indicates an integer of from 0 to 3); in indicates an integer of from 0 to 10.

When a functional group of large polarity is introduced into the substituent of X to X³ and Y¹ to Y³, then the thickness-direction retardation (Rth) of the formed film may be large, and the in-plane retardation (Re) expressibility thereof may also be large. The film having large Re expressibility may have a large Re value after stretched in the film formation process.

Norbornene-type addition (co)polymers are disclosed in Japanese Laid-Open Patent Publication No. 10-7732, Japanese Translation Of PCT International Application No. 2002-504184, US2004229157A1 or WO2004/070463A1. They may be obtained through addition polymerization of norbornene-type polycyclic unsaturated compounds. If desired, a norbornene-type polycyclic unsaturated compound may be subjected to addition polymerization with a conjugated diene such as ethylene, propylene, butene, butadiene, isoprene; non-conjugated diene such as ethylidene norbornene; or a linear diene compound such as acrylonitrile, acrylic acid, methacrylic acid, maleic anhydride, acrylate, methacrylate, maleimide, vinyl acetate, vinyl chloride. Such norbornene-type addition (co)polymers are sold by Mitsui Chemical as trade name of Apel having a different glass transition temperature (Tg), including chemical grades of APL8008T (Tg 70° C.), APL6013T (Tg 125° C.) and APL6015T (Tg 145° C.). Pellets of TOPAS8007, 6013 and 6015 are sold by Polyplastic. Further, Appear3000 is sold by Ferrania.

Norbornene polymer hydrides are produced by polymerizing polycyclic unsaturated compounds in a mode of addition polymerization or metathesis ring-cleavage polymerization and subjecting the resulting polymer to hydrogenation, as disclosed in Japanese Laid-Open Patent Publication Nos. 1-240517, 7-196736, 60-26024, 62-19801, 2003-1159767, 2004-309979. For the norbornene-type polymer for use in the invention, preferred are those where R⁵ and R⁶ each are a hydrogen atom or —CH₃; X³ and Y³ each are a hydrogen atom, Cl, or —COOCH₃, and the other groups may be suitably selected. The norbornene-type polymers of the type are sold by JSR as trade name of Arton G or Arton F. They are also sold by Nippon Zeon as trade name of Zeonor ZF14 or ZF16, or Zeonox 250 or 280. These may be used in the invention.

In preparing the retardation member, any other material than the above may also be used. As the other material, preferred are those having excellent transparency, mechanical strength, thermal stability and water sealability. For example, they include polyester polymers such as polyethylene terephthalate, polyethylene naphthalate; acrylic polymers such as polymethyl methacrylate; styrene polymers such as polystyrene, acrylonitrile/styrene copolymer (AS resin); and polycarbonate polymers. In addition, as other examples of the polymer capable of foaming the retardation member, further mentioned are polyolefin polymers such as polyethylene, polypropylene, polyolefin, ethylene/propylene copolymer; vinyl chloride polymers; amide polymers such as nylon, aromatic polyamide; imide polymers, sulfone polymers, polyether sulfone polymers, polyether ether ketone polymers, polyphenylene sulfide polymers, vinyl alcohol polymers, vinylidene chloride polymers, vinylbutyral polymers, acrylate polymers, polyoxymethylene polymers, epoxy polymers, and blends of the above-mentioned polymers. In addition, the retardation member may also be formed as a cured layer of a thermosetting or UV-curable polymer such as acrylic polymer, urethane polymer, acrylurethane polymer, epoxy polymer or silicone polymer.

### Method for Preparing Retardation Member:

In case where the retardation member is a polymer film, then the polymer film may be prepared by hot-melting a thermoplastic polymer, or may be prepared by casting a uniform dope of a polymer according to a solvent-casting method. Preferably, the film is prepared according to a solvent-casting method. The solvent-casting method is described below.

### (Solvent-Casting Method for Preparing Film)

In case where the polymer film for the retardation member is produced according to a solvent-casting method, a dope is first prepared by dissolving a polymer of a starting material for the film in a suitable organic solvent, and then the dope is cast onto a suitable support (preferably a metal support). Next, the solvent is evaporated away, and when the film has gelled, it is peeled away from the support, and thereafter the solvent is fully dried up from the film.

When the film is peeled away from the support, it is desirable that the residual solvent amount in the film is from 60 to 150%. The residual solvent amount may be represented by the following formula. The residual volatile weight is a value obtained by subtracting the weight of the film heated at 120° C. for 2 hours, from the weight of the film before the heat treatment.

Residual Solvent Amount=(residual volatile weight/film weight after heat treatment)×100(%).

After peeled away from the support, the film is dried. In the drying step, the film tends to shrink generally in the cross direction (direction perpendicular to the machine direction) owing to the evaporation of the solvent. Preferably, the film is so controlled that the film is not shrunk strongly in both directions of the machine direction and the direction perpendicular to it. Concretely, during film transportation in the machine direction, it is desirable that the tension to be applied to the film from the film transportation roll in the machine direction is controlled to fall between 10 and 50 kgf/m. On the other hand, it is also desirable that the tension to be applied to the film in the direction perpendicular to the machine direction is also the same level as above. In this case, a tenter system may be preferably employed, in which tenter clips are used for tension control while keeping the film in the cross direction. For example, preferably employed herein is a drying method (according to a tenter system) where both edges of the web to be dried are held with clips in the cross direction for controlling the width of the web entirely or partly in the drying step, as in Japanese Laid-Open Patent Publication No. 62-46625.

In case where an a-plate, a c-plate or a biaxial anisotropic plate is formed of a polymer film such as a cellulose acylate film or a cycloolefin film, it is desirable that the film for the plate is stretched.

In general, the film for a-plate is monoaxially stretched, and the film for a c-plate or a biaxial anisotropic plate may be biaxially stretched. As the case may be, the film for a c-plate may not be stretched.

The stretching method is described, for example, in Japanese L aid-open Patent Publication Nos. 62-115035, 4-152125, 4-284211, 4-298310, 11-48271. In order that the in-plane retardation of the film can be high, the film is stretched. In general, the film is stretched at room temperature or under heat. The heating temperature is preferably not higher than the glass transition temperature of the film. The film may be stretched monoaxially in the machine direction or in the cross direction, or may be simultaneously or successively biaxially stretched. The stretching may be effected by from 1 to 200%. Preferably, the stretching is by from 1 to 100%, more preferably by from 1 to 50%. Regarding the birefringence of the film, it is desirable that the refractive index of the film in the cross direction may be larger than the refractive index thereof in the machine direction. Accordingly, it is desirable that the film is stretched more in the cross direction. The film may be stretched while it is formed, or after once wound up, the film may be stretched. In the former case, the film may be stretched while it still contain a residual solvent, and it is preferably stretched while having a residual solvent amount of from 2 to 30%.

The stretching step and the shrinking step may be effected at a temperature falling from the glass transition temperature of the film to the crystallization temperature thereof/

### Optically-Anisotropic Layer:

The retardation member may comprise a substrate such as a polymer film and an optically-anisotropic layer formed on the substrate. The optically-anisotropic layer may be directly formed on the polymer film; but preferably, an alignment layer is formed on the polymer film and the optically-anisotropic layer is formed on it.

The optically-anisotropic layer may be formed of a liquid-crystal composition containing a liquid-crystal compound. The liquid-crystal compound is preferably a discotic compound (discotic liquid crystal) or a rod-shaped liquid crystal.

The discotic liquid crystal may be selected from compounds having a discotic core part and having a structure side branches radically extending from it, like triphenylene derivatives. For fixing the once aligned state thereof, the liquid-crystal compound preferably has a group capable of being reactive under heat or light. Preferred examples of the discotic liquid crystal are described in Japanese Laid-Open Patent Publication No. 8-50206.

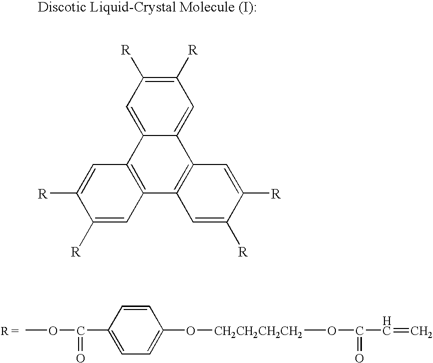

One example of the optically-anisotropic layer may be formed generally by applying a solution, which is prepared by dissolving a discotic compound and any other compound (additionally, for example, a polymerizing monomer, a photopolymerization initiator) in a solvent, onto an alignment layer, then drying it, and heating it up to a discotic nematic phase-forming temperature, and polymerizing it through irradiation with UV rays, and thereafter cooling it. The discotic nematic liquid-crystal phase-solid phase transition temperature of the discotic liquid-crystal compound is preferably from 70 to 300° C., more preferably from 70 to 170° C.

The other compound than the discotic compound that may be added to the optically-anisotropic layer-forming composition may be any and every compound which is compatible with the discotic compound and which may promote the desired alignment state of the discotic compound (for example, the discotic liquid-crystal compound molecules may be aligned in a preferred tilt angle (this is an angle of the discotic face of the molecule to the layer face)), or may not interfere with the desired alignment state of the discotic compound. Examples of the additives are polymerizing monomer (e.g., compound having a vinyl group, a vinyloxy group, an acryloyl group or a methacryloyl group); an additive for control of alignment on the air interface side, such as a fluorine-containing triazine compound; and a polymer such as cellulose acetate, cellulose acetate propionate, hydroxypropyl cellulose, cellulose acetate butyrate. These compounds may be in the layer in an amount of generally from 0.1 to 50% by mass, preferably from 0.1 to 30% by mass of the discotic compound therein. Preferably, the thickness of the optically-anisotropic layer is from 0.1 to 10 μm, more preferably from 0.5 to 5 μm.

Examples of the rod-shaped liquid-crystal compound usable in forming the optically-anisotropic layer include azomethines, azoxy compounds, cyanobiphenyls, cyanophenyl esters, benzoates, phenyl cyclohexanecarboxylates, cyanophenylcyclohexanes, cyano-substituted phenylpyrimidines, alkoxy-substituted phenylpyrimidines, phenyldioxanes, tolans, and alkenylcyclohexylbenzonitriles. Not only these low-molecular liquid-crystal compounds, but also polymer liquid-crystal compounds may be used herein.

In the optically-anisotropic layer, the alignment state of the rod-shaped liquid-crystal compound molecules are preferably fixed, and most preferably fixed through polymerization. Examples of the polymerizing rod-shaped liquid-crystal compound usable in the invention include the compounds described in Makromol. Chem., Vol. 190, p. 2255 (1989); Advanced Materials, Vol. 5, p. 107 (1993); U.S. Pat. Nos. 4,683,327, 5,622,648, 5,770,107, WO95/22586, 95/24455, 97/00600, 98/23580, 98/52905; Japanese Laid-Open Patent Publication Nos. 1-272551, 6-16616, 7-110469, 11-80081, 2001-328973.

The optically-anisotropic layer may be a layer formed by solidifying a cholesteric liquid-crystal phase having a selective reflection wavelength range of at most 350 nm. For the cholesteric liquid crystal, usable is a material having a selective reflection characteristic, for example, as described in Japanese Laid-Open Patent Publication No. 3-67219, 3-140921, 5-61039, 6-186534, 9-133810. From the viewpoint of the stability of the alignment fixed layer, preferably used is a composition containing a cholesteric liquid-crystal polymer, a chiral agent-containing nematic liquid-crystal polymer, or a compound capable of forming such a liquid-crystal polymer through optical or thermal polymerization, and exhibiting a cholesteric liquid-crystal phase.

The optically-anisotropic layer of this embodiment may be formed, for example, by applying a cholesteric liquid crystal onto a supporting substrate. In this case, if desired, the same or different type of a cholesteric liquid crystal may be superposed for retardation control. The coating method is not specifically defined. For example, any suitable method of gravure coating, die coating or dipping may be employed. For the supporting substrate, usable are the above-mentioned triacylate films or other polymer films.

In forming the optically-anisotropic layer from the liquid-crystal composition, a technique is necessary for aligning the liquid-crystal compound in the composition in a desired alignment state. For example, generally employed is a technique of using an alignment film for aligning liquid-crystal molecules in a desired direction. The alignment film includes a rubbed film of an organic compound such as polymer; an oblique deposition film of an inorganic compound; a microgrooved film; and a laminate film of LB layers formed according to a Langmuir-Blodgett's method of depositing an organic compound such as ω-tricosanoic acid, dioctadecylmethylammonium chloride, methyl stearate. It further includes an alignment film capable of exhibiting an alignment function through irradiation with light. As the alignment film, preferred is a surface-rubbed film of a polymer layer. The rubbing treatment may be effected by rubbing the surface of a polymer layer a few times in a predetermined direction, using paper or cloth. Preferred examples of the polymer for use for the alignment layer are polyimide, polyvinyl alcohol, and a polymerizing group-having polymer as in Japanese Laid-Open Patent Publication No. 9-152509. The thickness of the alignment layer is preferably from 0.01 to 5 μm, more preferably from 0.05 to 2 μm.

In addition, also employable herein are a technique of applying a liquid crystal onto a stretched film and aligning it thereon (Japanese Laid-Open Patent Publication No. 3-9325); and a technique of aligning a liquid crystal in the presence of an electric field or a magnetic field applied thereto. Preferably, the alignment state of the liquid crystal is as uniform as possible; and also preferably, the alignment film is a fixed layer in which the liquid crystal is fixed as in the alignment state thereof.

In case where a c-plate is formed by the use of a discotic liquid crystal material, then the method described in Japanese Laid-Open Patent Publication No. 2005-173567 is applicable to it; and in case where an a-plate is formed, the method described in Japanese Laid-Open Patent Publication No. 2005-194451 is applicable to it. In case where a c-plate is formed of a rod-shaped liquid crystal, an ordinary vertical alignment film may be used; and also in forming an a-plate, an alignment film of PVA may be readily prepared by rubbing and may be used for it.

The optically-anisotropic layer may be a polymer layer formed by applying a non-liquid-crystal composition, which is prepared by dissolving a non-liquid-crystal compound (essentially a polymer) in a solvent, onto a support, and drying it under heat thereon. In this case, the non-liquid-crystal compound may be, for example, a polymer such as polyamide, polyimide, polyester, polyether ketone, polyaryl ether ketone, polyamidimide, polyesterimide, as having excellent heat resistance, chemical resistance and transparency and having good rigidity. One or more these polymers may be used either singly or as combined. For example, a mixture of two or more different types of polymers having a different functional group, such as a mixture of polyaryl ether ketone and polyamide may be used. Of those polymers, more preferred is polyimide as having high transparency, high alignability, and high stretchability. The support is preferably a cellulose acylate film, more preferably a triacetyl cellulose film.

A laminate of a non-liquid-crystal layer and a support may be stretched in the cross direction by from 1.05 to 1.50 times, by the use of a tenter to form the retardation member.

In case where the retardation member is a laminate of a support such as a polymer film and the above-mentioned optically-anisotropic layer, it is desirable that the retardation member is stuck to a polarizing element in such a manner that the back of the support of a polymer film (the face not coated with the optically-anisotropic layer) could face the polarizing element. However, the constitution of the type is not limitative in the invention.

### [Polarized Light Generating Member]

In the invention, the term “polarized light generating member” means a member of such that, when outputted light passes through the member, at least a part or all of light is polarized through it. For example, the polarized light generating member may be a member that exhibits anisotropy to linearly polarized lights of which the vibration directions are perpendicularly to each other, or for example, a member that exhibits scattering anisotropy to linearly polarized lights of which the vibration directions are perpendicularly to each other, or may be a member that exhibits anisotropy to the transmittance and/or the reflectance thereof. For the polarized light generating member, preferably used is a member generally used as a brightness improving film in ordinary liquid-crystal display devices. The brightness improving film is disposed on the side of the light source (backlight), and this is a light-polarization converting element that has a function of separating incident light into transmitting polarized light and reflecting polarized light or scattering polarizing light. The brightness improving film of the type has a function that utilizes returning light of reflecting polarized light or scattering polarized light from a backlight and improves the output efficiency of linearly polarized light.

Examples of the brightness improving film, which can be used in the invention, include an anisotropic reflective polarizing element. Examples of the anisotropic reflective polarizing element include an anisotropic multi-layer thin film capable of transmitting linearly polarized light in one vibration direction and reflecting linearly polarized light in the other vibration direction. Examples of the anisotropic multi-layer thin film include, for example, 3M's DBEF (e.g., see Japanese Laid-Open Patent Publication No. 4-268505). Examples of the anisotropic reflective polarizing element include a combination of a cholesteric liquid-crystal layer and a λ/4 plate. Examples of such a combination include Nitto Denko's PCF (see Japanese Laid-Open Patent Publication No. 11-231130). Examples of the anisotropic reflective polarizing element also include a reflective grid polarizing element. Examples of the reflective grid polarizing element include a metal grid reflective polarizing element disclosed in U.S. Pat. No. 6,288,840, produced by microprocessing a metal so as to give a reflective polarized light even in a visible light region; and a member disclosed in Japanese Laid-Open Patent Publication No. 8-184701, produced by stretching a polymer composition in which metal particles are dispersed in polymer matrix.

For the polarized light generating member, also usable is an anisotropic scattering polarizing element that is heretofore used as a brightness improving film. Examples of the anisotropic scattering polarizing element include 3M's DRP (see U.S. Pat. No. 5,825,543).

For the polarized light generating member, also usable is a polarizing element enabling one-pass polarized light conversion, which is heretofore used as a brightness improving film. Examples of the element include an element produced by employing smectic C* (see Japanese Laid-Open Patent Publication No. 2001-201635). For the polarized light generating member, also usable is an anisotropic diffraction grating that is heretofore used as a brightness improving film.

In case where a brightness improving film that has a function of transmitting linearly polarized light having a first vibration direction, and reflecting another linearly polarized light having a vibration direction perpendicular to the first vibration direction the other, is used as the polarized light generating member, it is preferable that the polarized light generating member has, thereon, a reflective layer capable of again reflecting polarized light reflected by the member to thereby make light go back to the member. Further, when the brightness improving film having the function is used as the polarized light generating member, then a diffusive plate may be disposed between the polarized light generating member and the reflective layer. Polarized light reflected by the polarized light generating member may be reflected by the reflective layer and may go back to the polarized light generating member; however, the diffusive plate thus disposed may unify the diffusion of light that passes through the diffusive plate and, at the same time, reflected polarized light may be depolarized, or that is, reflected polarized light is converted into non-polarized light. Accordingly, the diffusive plate depolarizes incident light and converts polarized light into original natural light. Then, non-polarized light, natural light, goes toward the reflective layer, then reflected by the reflective layer, thereafter again goes through the diffusive plate, then reenter into the brightness improving film; and this cycle is repeated. Disposing the diffusive plate capable of depolarizing polarized light and converting it into original natural light between the brightness improving film and the reflective layer, it is possible to obtain not only the effect of the invention but also improvement in brightness of the display panel. Thus, it is possible to provide a uniform and bright panel. Disposing such a diffusive plate, reflection frequency of initial incident light increases, and, therefore, with diffusive ability of the diffusive plate, this advantage may make it possible to provide a uniform and bright display panel,

### [Polarizing Element]

The liquid-crystal display device of the invention comprises first and second polarizing elements. Not specifically defined, various types of polarizing elements may be used in the invention. The polarizing elements include, for example, those produced by making a hydrophilic polymer film such as a polyvinyl alcohol film, a partially-formalized polyvinyl alcohol film, or a partially saponified, ethylene/vinyl acetate copolymer film adsorb a dichroic substance such as iodine or a dichroic dye and monoaxially stretching the resulting film; and a polyene-type oriented film such as a dehydrochlorination-treated polyvinyl chloride film. Of those, preferred is the film produced by stretching a polyvinyl alcohol film, then making it adsorb a dichroic coloring matter (iodine, dye), and orienting it. Not specifically defined, the thickness of the polarizing element is generally from 5 to 80 μm or so.

The polarizing element to be produced by coloring a polyvinyl alcohol film with iodine and monoaxially stretching it may be, for example, produced by dipping a polyvinyl alcohol film in an aqueous solution of iodine to color it, and then stretching it by from 3 to 7 times the original length. If desired, the film may be dipped in an aqueous solution of boric acid or potassium iodide. Further if desired, the polyvinyl alcohol film may be dipped and swollen in water and then rinsed with water, before colored. Rinsing the polyvinyl alcohol film with water may wash away the surface staining of the polyvinyl alcohol film and may wash away the blocking inhibitor from the film, and in addition, the rinsing is further effective for swelling the polyvinyl alcohol film to thereby prevent uneven processing such as uneven dyeing. The stretching may be effected after the coloration with iodine, or may be effected during the coloration, or after stretched, the film may be colored with iodine. The film may also be stretched in an aqueous solution of boric acid or potassium iodide or in a water bath.

To solve the problem of display unevenness at the time of black level of display owing to the coloring unevenness (coloring distribution) of the polarizing element with iodine that the element contains, it is desirable that the polyvinyl alcohol film for the element is processed for welling and coloration (the coloring bath may contain potassium iodide, in addition to the dichroic dye such as iodine), or crosslinking (the crosslinking bath may contain potassium iodide in addition to the crosslinking agent such as boric acid), or stretching (the stretching bath may contain boric acid or potassium iodide), or rinsing with water.

The reason for the coloration unevenness includes the thickness unevenness of the polyvinyl alcohol film (Japanese Laid-Open Patent Publication Nos. 2000-216380, 2002-31720). Even though the problem is solved or the thickness is uneven within a large range (in-plane range of at least 50 cm, preferably at least 75 cm, more preferably at least 100 cm), the display unevenness is difficult to find in ordinary polarizer applications. In order to observe the unevenness at the time of black level of display, the unevenness may be recognized when there are some brightness density peaks in a range of from 5 cm to 20 cm on the polarizing element or the polarizer; but when the peaks are over the range, then any remarkable display uneveness could not be recognized. In addition, when the peaks are within a range of 5 nm or so or are smaller than it and are uneven and when there is some iodine coloration density unevenness, the black brightness would merely increase on average. The adsorption orientation of iodine may depend on the thickness of the polyvinyl alcohol film, and when the film is thicker, then the film may adsorb a larger amount of iodine and may be oriented to a higher degree.

A uniform polyvinyl alcohol film having little thickness unevenness is preferably used for forming the polarizing element. The polyvinyl alcohol film for the polarizing element may have maximum and minimum levels of the film thickness within an in-plane range of from 100 to 400 mm, and it is desirable that the difference between them is at most 5 μm, more preferably at most 3 μm, even more preferably at most 1 μm. When the thickness distribution of the film is larger than the range, then the film is preferably subjected to swelling treatment in pure water or ion-exchanged water (at 15 to 40° C., for 50 to 180 seconds, at a draw ratio in stretching of from 2 to 3.8 times), or dyeing treatment (in an aqueous solution of iodine and potassium iodide dissolved in a ratio of from 1/6 to 1/50, for 10 to 60 seconds; the concentration of the solution varies depending on the transmittance and the degree of polarization characteristics to be planed, and may be from 0.05% to 3%; the draw ration in stretching is from 1.2 to 2 times), or boric acid crosslinking treatment (at 25 to 45° C., at a draw ratio in stretching of from 1.1 to 2 times, and at a potassium iodine concentration of from 0 to 5%), and further stretching treatment (at a boric acid concentration of from 2 to 8%, a potassium iodide concentration of from 0 to 10%, at a temperature of from 30 to 65° C., and at a draw ratio in stretching of from 1.7 to 3 times) and rinsing treatment in water (at a potassium iodide concentration of from 2 to 10%), whereby the film is stretched preferably by from 5 to 6.5 times in total. Regarding the width of the thus-stretched film, when the film is stretched by x times, then both the thickness and the width of the film are preferably 1/√x times. The thickness may be smaller than it by 10%, at worst by about 25%. The width may be broader than it by 10%, at worst by about 25%. The stretched film is then dried at 25 to 40° C. for 30 to 300 seconds, whereby its water content is controlled to be preferably from 12% to 28% (more preferably from 14 to 25%).

### [Retardation Plate for Liquid-Crystal Cell Compensation]

The liquid-crystal display device of the invention may have a retardation plate between the liquid-crystal cell and the first polarizing element and/or the second polarizing element, in addition to the above-mentioned retardation member therein. For the retardation plate, for example, usable are various wavelength plates and those heretofore used for the purpose of optical compensation for the coloration owing to birefringence of liquid-crystal cell or for viewing angle compensation. For example, a viewing angle compensation film that acts to broaden the viewing angle range for the purpose of sharp image display even when seen not in the vertical direction but in the oblique direction may be used as the retardation plate. A laminate plate produced by laminating at least two retardation plates having a suitable retardation level, in accordance with the use and the object thereof, may also be used as the retardation plate. Examples of the materials for the retardation plate for optical compensation of liquid-crystal cell may be the same as those mentioned hereinabove for the material of the above-mentioned retardation member. In addition, a retardation film having an optically-anisotropic layer formed by homeotropically aligning a liquid-crystal composition and fixing it in the aligned state may also be used as the retardation plate, singly or as combined with any other retardation film.

Examples of the viewing angle compensatory retardation film usable in the invention include a film having birefringence, which is biaxially stretched or stretched in two directions crossing perpendicularly to each other, and a two-directional stretched film such as an oblique-stretched film. The oblique-stretched film includes, for example, those produced by sticking a thermoshrinkable film to a polymer film and stretching and/or shrinking the polymer film under the shrinking power thereof by heat; and those produced by obliquely aligning a liquid-crystal polymer. Two or more such polymer films may be combined in order that they may satisfy various objects of preventing or reducing coloration owing to the viewing angle fluctuation caused by the birefringence of liquid-crystal cell or for broadening the viewing angle range for good display visibility, and the thus-combined films may be used in the liquid-crystal display device of the invention.

In terms of attaining the broadened viewing angle for good display visibility, an optically-compensatory retardation plate which has an optically-anisotropic layer of an aligned liquid-crystal polymer, especially of a hybrid-aligned discotic liquid-crystal polymer formed on a polymer film such as a triacetyl cellulose film, is favorable for the above retardation plate.

The retardation plate may be an independent plate member in the liquid-crystal display device, or may be laminated on the polarizing element so as to be a part member of the broad viewing angle polarizer in liquid-crystal display device.

### [Liquid-Crystal Cell]

The mode of the liquid-crystal cell to be in the liquid-crystal display device of the invention is not specifically defined. It is preferably a TN mode, a VA mode, an OCB mode, an IPS mode or an ECB mode.

### TN Mode:

In the TN-mode liquid-crystal cell, the rod-shaped liquid-crystal molecules are aligned substantially horizontally in no voltage application thereto, and are twisted at a twisting angle of from 60 to 120° or so. The TN-mode liquid-crystal cell is most popularly utilized as a color TFT liquid-crystal display device, and is described in many references, which are applicable to the invention.

### VA Mode:

In the VA-mode liquid-crystal cell, the rod-shaped liquid-crystal molecules are aligned substantially vertically in no voltage application thereto. The VA-mode liquid-crystal cell includes (1) a VA-mode liquid-crystal cell in the narrow sense of the word, in which the rod-shaped liquid-crystal molecules are substantially vertically aligned in the absence of voltage application thereto but are substantially horizontally aligned in the presence of voltage application thereto (as in Japanese Laid-Open Patent Publication No. 2-176625), further including in addition to it, (2) a multi-domain VA-mode (MVA-mode) liquid crystal cell for viewing angle expansion (as in SID97, Digest of Tech. Papers (preprint), 28 (1997) 845), (3) an n-ASM-mode liquid-crystal cell in which the rod-shaped liquid-crystal molecules are substantially vertically aligned in the absence of voltage application thereto but are subjected to twisted multi-domain alignment in the presence of voltage application thereto (as in the preprint in the Nippon Liquid Crystal Discussion Meeting, 58-59 (1998)), and (4) a SURVIVAL-mode liquid-crystal cell (as announced in LCD International 98). In the liquid-crystal display device of the invention, any of those VA-mode liquid-crystal cells may be used.

### OCB Mode:

The OCB-mode liquid-crystal cell is a bent-alignment mode liquid-crystal cell in which the rod-shaped liquid-crystal molecules are aligned substantially in the opposite directions (symmetrically) between the upper part and the lower part of the liquid-crystal cell. This is disclosed in U.S. Pat. Nos. 4,583,825 and 5,410,422. In this, since the rod-shaped liquid-crystal molecules are symmetrically aligned in the upper part and the lower part of the liquid-crystal cell, the bent-alignment mode liquid-crystal cell has a self-optically-compensatory function. Accordingly, the liquid-crystal mode of the type is referred to as an OCB (optically-compensatory bent) liquid-crystal mode. The bent-alignment mode liquid-crystal display device has an advantage of rapid response speed. Accordingly, when the OCB-mode liquid-crystal cell is used in the liquid-crystal display device of the invention, then the device may exhibit the effect of the invention and may have rapid response speed.

### IPS Mode:

The IPS-mode liquid-crystal cell is a system where the nematic liquid crystal is switched by horizontal electric field application thereto. Its details are described in Proc. IDRC (Asia Display '95), pp. 577-580 and ibid., pp. 707-710.

### ECB Mode:

The ECB-mode liquid-crystal cell is a system where the rod-shaped liquid-crystal molecules are substantially horizontally aligned in no voltage application thereto. The ECB mode is one liquid-crystal display mode having a most simple structure, and is described in detail, for example, in Japanese Laid-Open Patent Publication No. 5-203946.

Methods for measuring various physical data as referred to in this description are described below.

### [Retardation]

In this description, Re(λ) and Rth(λ) are an in-plane retardation (nm) and a thickness-direction retardation (nm), respectively, at a wavelength of λ. Re(λ) is determined by applying light having a wavelength of λ nm to a film in the normal direction of the film, using KOBRA 21ADH or WR (by Oji Scientific Instruments).

In this description, a retardation of a retardation member in a direction at a polar angle of 60° and an azimuthal angle of 45° with respect to an in-plane slow axis of the retardation member, “effective Re” is measured for a sample disposed on an inclined stage using KOBRA 21 WR.

When the film to be analyzed is represented by a monoaxial or biaxial index ellipsoid, then its Rth(λ) may be computed as follows:

Re(λ) of the film is measured around the slow axis (judged by KOBRA 21ADH or WR) as the in-plane tilt axis (rotation axis) (when the film does not have a slow axis, then its rotation axis may be in any in-plane direction of the film), relative to the normal direction of the film up to 50 degrees on one side of the film at intervals of 10 degrees, in 6 points in all with a light having a wavelength of λ nm applied in the inclined direction; and based on the thus-measured retardation values, the estimated value of the mean refractive index and the inputted film thickness value, Rth(X) of the film may be computed by KOBRA 21 ADH or WR.

In the above, when the film to be analyzed has a direction in which the retardation value is zero at a certain tilt angle, around the in-plane slow axis from the normal direction as the rotation axis, then the retardation date at the tilt angle larger than the inclination angle is changed to negative data, and then the Rth(λ) of the film is computed by KOBRA 21ADH or WR.

Around the slow axis as the tilt angle (rotation angle) of the film (when the film does not have a slow axis, then its rotation axis may be in any in-plane direction of the film), the retardation values are measured in any desired inclined two directions, and based on the data, and the estimated value of the mean refractive index and the inputted film thickness value, Rth may be computed according to the following formulae (1) and (2):

$$\begin{matrix}Re ( θ ) = [ nx - \frac{( ny \times nz )}{\sqrt{\begin{matrix}{\{ ny sin ( {sin}^{- 1} ( \frac{sin ( {}_{-} θ )}{nx} ) ) \}}^{2} + \\ {\{ nz cos ( {sin}^{- 1} ( \frac{sin ( {}_{-} θ )}{nx} ) ) \}}^{2}\end{matrix}}} ] \times \frac{d}{cos \{ {sin}^{- 1} ( \frac{sin ( {}_{-} θ )}{nx} ) \}} & ( 1 ) \\ Rth = \{ ( nx + ny ) / 2 - nz \} \times d & ( 2 )\end{matrix}$$

wherein Re(θ) represents a retardation value in the direction inclined by an angle θ from the normal direction; nx represents a refractive index in the in-plane slow axis direction; ny represents a refractive index in the in-plane direction perpendicular to nx; and nz represents a refractive index in the direction perpendicular to nx and ny. And “d” is a thickness (nm) of the sample.

When the film to be analyzed is not expressed by a monoaxial or biaxial index ellipsoid, or that is, when the film does not have an optical axis, then Rth(X) of the film may be computed as follows:

Re(X) of the film is measured around the slow axis (judged by KOBRA 21ADH or WR) as the in-plane tilt axis (rotation axis), relative to the normal direction of the film from −50 degrees up to +50 degrees at intervals of 10 degrees, in 11 points in all with a light having a wavelength of λ nm applied in the inclined direction; and based on the thus-measured retardation values, the estimated value of the mean refractive index and the inputted film thickness value, Rth(λ) of the film may be computed by KOBRA 21ADH or WR.

### EXAMPLES

The invention is described concretely with reference to the following Examples and Comparative Examples, in which “%” are all by mass %.

### (Formation of Polarizing Element)

A non-processed polyvinyl alcohol film (Kuraray's vinylon film VF-9P75RS) was used. While dipped in pure water at 30° C. for 120 seconds, the film was stretched at a draw ratio of 2 times and swollen. Next, while dipped in a dyeing bath (this is an aqueous solution prepared by dissolving iodine and potassium iodide in a ratio of 1/10 by mass, and its concentration was so controlled that the final simple-substance transmittance could be 44.0%) for 50 seconds, this was stretched at a draw ratio of 1.5 times and dyed. Next, while dipped in a boric acid crosslinking bath (30° C., boric acid concentration 5%, potassium iodide concentration 2%), this was stretched at a draw ratio of 1.1 times and crosslinked with boric acid. Next, while dipped in a stretching bath (60° C., boric acid concentration 5%, potassium iodide concentration 5%), this was stretched at a draw ratio of 1.8 times. Next, while dipped in a rinsing bath (potassium iodide concentration 5%) for 5 seconds, this was stretched to a total draw ratio of 6.1 times, and rinsed. Next, this was dried to as to have a controlled water content of 20%.

### (Retardation Member A)

A triacetyl cellulose film having a thickness of 82 μm (Wide View Film WV BZ438, by Fiji Photo Film) was dipped in an aqueous 5% sodium hydroxide solution at 40° C. for 2 minutes, then rinsed with pure water at 30° C. for 1 minute, and thereafter dried at 100° C. for 2 minutes for saponification.

Two sheets of the above-saponified films were stuck together using an aqueous 5% solution containing 75 parts of polyvinyl alcohol (NH-18 by Nippon Gohsei) and 25 parts of glyoxal, thereby obtaining a laminate film. The film had an in-plane retardation Re of 100 nm and a thickness-direction retardation Rth of 400 nm. Its wavelength dependence satisfied the formula (B). It was also found that the film was biaxial and its effective Re was 231 nm.

### (Retardation Member B)

### <Production of Cyclic Polyolefin Polymer P-1>

100 parts by mass of pure toluene and 100 parts by mass of methyl norbornenecarboxylate were put into a reactor. Next, 25 nμmol % (relative to the monomer mass) of ethylhexanoate-Ni dissolved in toluene, 0.225 mol % (relative to the monomer mass) of tri(pentafluorophenyl)boron, and 0.25 mol % (relative to the monomer mass) of triethylaluminium dissolved in toluene were put into the reactor. While stirred at room temperature, these were reacted for 18 hours. After the reaction, the reaction mixture was put into excessive ethanol, thereby forming a copolymer precipitate. The copolymer (P-1) obtained by purifying the precipitate was dried in vacuum at 65° C. for 24 hours.

The following composition was put into a mixing tank and stirred to dissolve the constitutive components therein, and then filtered through a paper filter having a mean pore size of 34 μm and through a sintered metal filter having a mean pore size of 10 nm.

Solution of Cyclic Olefin-type Addition Polymer

| | |
|---|---|
| Cyclic Olefin-type Addition Polymer P-1 | 150 mas. pts. |
| Methylene Chloride | 400 mas. pts. |
| Methanol | 50 mas. pts. |

Next, the following composition containing the cyclic polyolefin solution prepared in the above was put into a disperser, thereby preparing a mat agent dispersion.

Mat Agent Dispersion

| | |
|---|---|
| Silica Particles having a mean particle size of 16 nm | 2.0 mas. pts. |
| (Aerosil R972, by Nippon Aerosil) | |
| Methylene Chloride | 72.4 mas. pts. |
| Methanol | 10.8 mas. pts. |
| Cyclic Olefin-type Addition Polymer Solution | 10.3 mas. pts. |

100 parts by mass of the above cyclic olefin-type addition polymer solution and 1.35 parts by mass of the mat agent dispersion were mixed, thereby preparing a dope for film formation.

The above dope was cast, using a band caster. Formed on the band, the film having a residual solvent amount of from 15 to 25% by mass was peeled away from the band, and stretched by 2% in the cross direction, using a tenter. Then, while kept so as not to be wrinkled, the film was dried with hot air at 120° C. applied thereto. Next, the film was transferred from tenter transportation to roll transportation, and further dried at 120° C. to 140° C., and then wound up. Thus produced, the film had a thickness of 61 μm. The film was freely monoaxially stretched by 15% to produce a film (F-21).

The above film F-21 was subjected to glow discharge treatment between upper and lower brass electrodes in an argon atmosphere (a high-frequency voltage of 4200 V at a frequency of 3000 Hz was applied between the upper and lower electrodes, and the film was processed for 20 seconds), thereby producing a film (F-22). The contact angle with pure water of the protective film surface processed through glow discharge treatment was everywhere 36°. The contact angle was measured, using a contact angle meter, Kyowa Kaimen Kagaku's CA-X Model.

### <Formation of Alignment Film>

A coating liquid having the composition mentioned below was applied onto the film (F-22) produced in the above, using a wire bar coater of #14, and the coating amount was 24 ml/m². This was dried with hot air at 60° C. for 60 seconds and then with hot air at 90° C. for 150 seconds.

(Composition of Coating Liquid for Alignment Film)

| | | |
|---|---|---|
| Modified Polyvinyl Alcohol having | 40 | mas.pts. |
| the following formula | | |
| Water | 728 | mas.pts. |
| Methanol | 228 | mas.pts. |
| Glutaraldehyde (crosslinking agent) | 2 | mas.pts. |
| Citric Acid | 0.08 | mas.pts. |
| Monoethyl Citrate | 0.29 | mas.pts. |
| Diethyl Citrate | 0.27 | mas.pts. |
| Triethyl Citrate | 0.05 | mas.pts. |

Modified Polyvinyl Alcohol

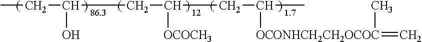

### <Formation of Optically-Anisotropic Layer>

A coating liquid containing a discotic liquid-crystal compound and having the composition mentioned below was applied onto the above alignment film, using a wire bar.

(Composition of Coating Liquid for discotic liquid-crystal layer)

| | | |
|---|---|---|
| Discotic Liquid-Crystal Compound TE-8 | 32.6 | mas. % |
| ((8) where m = 4) | | |
| Compound I-5 mentioned below | 0.05 | mas. % |
| Ethyleneoxide-modified Trimethylolpropane Triacrylate | 3.2 | mas. % |
| (V#360, by Osaka Organic Chemical) | | |
| Sensitizer | 0.4 | mas. % |
| (Kayacure DETX, by Nippon Kayaku) | | |
| Photopolymerization Initiator | 1.1 | mas. % |
| (Irgacure 907, by Ciba-Geigy) | | |
| Methyl Ethyl Ketone | 62.0 | mas. % |
| Compound P-75 mentioned below | 0.14 | mas. % |

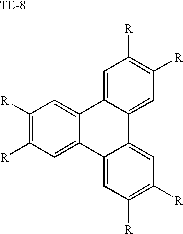

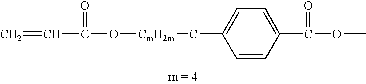

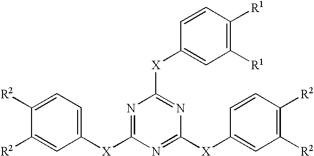

| Compound No. | R¹ | R² | X |
|---|---|---|---|
| I-5 | OCH₂(CF₂)₈H | OCH₂(CF₂)₈H | NH |

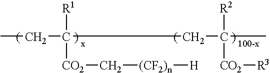

| | x | R¹ | n | R² | R³ | Mw |
|---|---|---|---|---|---|---|
| P-75 | 90 | H | 6 | CH₃ | —(CH₂CH₂O)₈—H | 9000 |

After coated with the above coating liquid, this was heated and dried in a drying zone at 130° C. for 2 minutes, whereby the molecules of the discotic liquid-crystal compound were aligned. Next, using a 120 W/cm high-pressure mercury lamp at 80° C. in the UV irradiation zone, this was irradiated with UV rays for 4 seconds, whereby the discotic liquid-crystal compound molecules were polymerized to give a film having a thickness of 5 μm.

The optical characteristics of the film inclusive of the support were Re=150 nm and Rth=600 nm, and the wavelength dependency of the film satisfied the formula (B). And it was also found that the film was biaxial and its effective Re was 89 nm.

### (Retardation Member C)

A triacetyl cellulose film having a thickness of 80 μm (TD80, by Fuji Photo Film) was dipped in an aqueous sodium hydroxide solution having a concentration of 5% at 40° C. for 2 minutes, then rinsed with pure water at 30° C. for 1 minute, and thereafter dried at 100° C. for 2 minutes for saponification.

The following acrylic acid copolymer and triethylamine (neutralizing agent) were dissolved in a mixed solvent of methanol/water (30/70 by mass) to prepare a 4 mas. % solution. Using a bar coater, the above solution was continuously applied onto the above saponified TD80. The coating layer was heated at 120° C. for 5 minutes and dried, thereby forming a layer having a thickness of 1 μm. Next, the surface of the coating layer was rubbed continuously in the machine direction (traveling direction), thereby forming an alignment film.

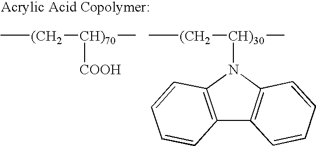

Using a bar coater, a coating liquid having the composition mentioned below was continuously applied onto the above alignment film. The coating layer was heated at 100° C. for 1 minute whereby the rod-shaped liquid-crystal molecules were aligned, and then this was irradiated with UV rays whereby the rod-shaped liquid-crystal molecules were polymerized and the alignment state was fixed to form an optically-anisotropic layer. The thickness of the optically-anisotropic layer was 2.1 μm.

Composition of Coating Liquid for optically-anisotropic layer

| | |
|---|---|
| Rod-Shaped Liquid-Crystal Compound mentioned below | 38.4 mas. % |
| Sensitizer mentioned below | 0.38 mas. % |
| Photopolymerization Initiator mentioned below | 1.15 mas. % |
| Air Interface Horizontal Aligning Agent mentioned below | 0.06 mas. % |
| Methyl Ethyl Ketone | 60.0 mas. % |

Rod-Shaped Liquid-Crystal Compound:

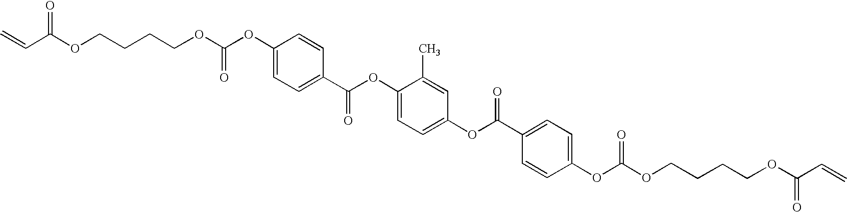

Sensitizer:

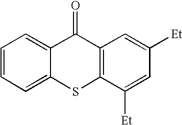

Photopolymerization Initiator:

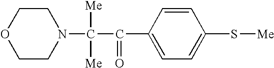

Air Interface Horizontal Aligning Agent:

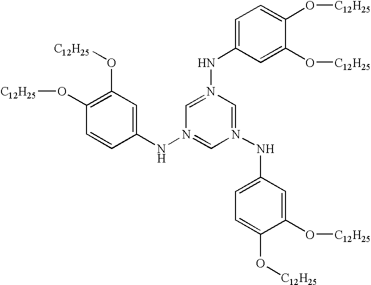

In the above optically-anisotropic layer, the rod-shaped liquid-crystal molecules were so aligned that their major axis direction crosses the machine direction of the rolled triacetyl acetate film TD80 perpendicularly to each other.

Further, on the opposite face of the coated substrate, an optically-anisotropic layer was formed in the same manner as that in the retardation member B. The thickness of the optically-anisotropic layer was 11 μm, in which the discotic faces of the discotic liquid-crystal molecules were aligned horizontally to the layer face.

The optical characteristics of the retardation member inclusive of TD80, the optically-anisotropic layer of discotic liquid-crystal and the optically-anisotropic layer formed of rod-shaped liquid-crystal were Re=200 nm and Rth=800 nm as a whole, and wavelength dependency of the member satisfied the formula (B). It was also found that the film was biaxial and its effective Re was 62 nm.

### (Retardation Member D)

A triacetyl cellulose film having a thickness of 80 m (TD80, by Fuji Photo Film) was dipped in an aqueous sodium hydroxide solution having a concentration of 5% at 40° C. for 2 minutes, then rinsed with pure water at 30° C. for 1 minute, and then dried at 100° C. for 2 minutes for saponification. This was used as a retardation member D. Re of the retardation member D was 2 nm; and the thickness-direction retardation thereof. Rth was 54 nm. The wavelength dependency of the member satisfied the formula (B). It was also found that the film was biaxial and its effective Re was 29 nm.

### (Brightness Improving Film a)

3M's DBEF (anisotropic multi-layer thin film) was used.

### (Brightness Improving Film B)

PCF400, by Nitto Denko (laminate of cholesteric liquid crystal and λ/4 plate) was used.

### (Liquid-Crystal Display Device A)

A VA-mode liquid-crystal display device, Sharp's 37GE2 was used.

### (Liquid-Crystal Display Device B)

An IPS-mode liquid-crystal display device, Toshiba's 32Z1000 was used.

### Example 1

An IPS mode liquid-crystal TV, Toshiba's 32Z1000 was disassembled, and the protective film and the retardation film on the liquid-crystal cell side were peeled away from the backside polarizer, and these were stuck to one side of the above-constructed polarizing element, using an aqueous 5% solution of 75 parts of polyvinyl alcohol (NH-18, by Nippon Gohsei) and 25 parts of glyoxal. On the other polarizing face of the thus-stuck polarizing element, the retardation member A was stuck in such a manner that the slow axis of the member A could correspond to the transmission axis of the polarizing element, and these were dried at 50° C. for 5 minutes, thereby producing a polarizer. On the surface of the retardation member A of the polarizer, the brightness improving film A was stuck with an acrylic transparent adhesive. Then, this was built into the above liquid-crystal TV, in place of the backside polarizer, and thus the device was re-constructed to have the same constitution as in the liquid-crystal display device of FIG. 1. In the thus-constructed device, the polarizer was so stuck to the brightness improving film A that the absorption axis of the polarizer could cross the transmission axis of the film A perpendicularly to each other.

### Examples 2 to 7, and Comparative Examples 1 to 2

Liquid-crystal display devices were constructed in the same manner as in Example 1, for which, however, the members were changed as in Table 1 below. When the retardation member B was used in place of the retardation member A, then it was stuck to the brightness improving film in such a manner that the back of the polymer film (not coated with an optically-anisotropic layer) faced the polarizing element and the optically-anisotropic layer faced the brightness improving film. When the retardation member C was used in place of the retardation member A, then it was stuck in such a manner that the optically-anisotropic layer formed of the rod-shaped liquid-crystal composition faced the polarizing element.

### (Color Shift Evaluation)

The liquid-crystal display devices thus constructed in the above were evaluated in terms of the degree of color shift. Concretely, each device in the black state was observed in the normal direction and in the oblique direction at 45 degrees relative to the absorption axis of the polarizer and at a polar angle of 60 degrees, and the color tone in the oblique direction was observed and compared with it in the normal direction, and, then, the color shift on the basis of the normal direction was evaluated according to an organoleptic test. The results are shown in Table 1.

A: The color tone in the oblique direction is neutral gray and the color shift is extremely small.
B: The color tone in the oblique direction is nearly neutral gray and the color shift is small.
C: The color tone in the oblique direction is not neutral gray and the color shift is large.

TABLE 1

| | | | | | | | | | Relationship between | |
|---|---|---|---|---|---|---|---|---|---|---|
| | | Polarized Light | | Retardation Member | | | | | Transmission Axis of | Result of |
| | | Generating | Liquid | | | | Wavelength | Effective | Polarizing Element | Color |
| | | Member | Crystal Cell | | Re(nm) | Rth(nm) | Dispersion | Re(nm) | and Slow Axis | Shift Test |
| Example | 1 | Brightness | Liquid Crystal | Retardation | 100 | 400 | B | 231 | perpendicular | A |
| | | Improving Film | Display | Member A | | | | | | |
| | | A | Device B | | | | | | | |
| Example | 2 | Brightness | Liquid Crystal | Retardation | 150 | 600 | B | 89 | perpendicular | A |
| | | Improving Film | Display | Member B | | | | | | |
| | | A | Device A | | | | | | | |
| Example | 3 | Brightness | Liquid Crystal | Retardation | 200 | 800 | B | 62 | perpendicular | A |
| | | Improving Film | Display | Member C | | | | | | |
| | | A | Device B | | | | | | | |
| Example | 4 | Brightness | Liquid Crystal | Retardation | 150 | 600 | B | 89 | parallel | B |
| | | Improving Film | Display | Member B | | | | | | |
| | | A | Device A | | | | | | | |
| Example | 5 | Brightness | Liquid Crystal | Retardation | 150 | 600 | B | 89 | perpendicular | A |
| | | Improving Film | Display | Member B | | | | | | |
| | | B | Device A | | | | | | | |
| Comparative | 6 | Brightness | Liquid Crystal | Retardation | 2 | 54 | B | 29 | parallel | C |
| Example | | Improving Film | Display | Member D | | | | | | (reddish) |
| | | A | Device A | | | | | | | |
| Comparative | 7 | Brightness | Liquid Crystal | Retardation | 2 | 54 | B | 29 | parallel | C |
| Example | | Improving Film | Display | Member D | | | | | | (bluish) |
| | | A | Device B | | | | | | | |

What is claimed is:

1. A liquid-crystal display device comprising at least, a member of generating polarized light, a retardation member, a first polarizing element, a liquid-crystal cell and a second polarizing element, in this order;
wherein the retardation member satisfies at least one condition of
(i) its in-plane retardation, Re, is from 10 nm to 3000 nm at a wavelength falling within a range from 400 to 780 nm, and
(ii) its thickness-direction retardation, Rth, is from 60 nm to 3000 nm at a wavelength falling within a range from 400 to 780 nm.

2. The liquid-crystal display device of claim 1, wherein the retardation member has a retardation, in a direction at a polar angel of 60° and an azimuthal angle of 45° with respect to an in-plane slow axis of the retardation member, falling with in a range from 50 nm to 1500 nm.

3. The liquid-crystal display device of claim 1, wherein the retardation member is a biaxial anisotropic plate.

4. The liquid-crystal display device as claimed in claim 1, wherein the retardation member is disposed so that its in-plane slow axis is in parallel with a polarization direction of the member of generating polarized light.

5. The liquid-crystal display device of claim 1, wherein the retardation member is directly adhered to the first polarizing element.

6. The liquid-crystal display device of claim 1, wherein the retardation member comprises a layer formed of a composition comprising a liquid-crystal compound.

7. The liquid-crystal display device of claim 1, wherein the retardation member is a polymer film or comprises a polymer film.

8. The liquid-crystal display device of claim 7, wherein the polymer film is a cellulose acylate film.

9. The liquid-crystal display device of claim 7, wherein the polymer film is a cyclic polyolefin film.

10. The liquid-crystal display device of claim 1, wherein the member of generating polarized light is a combination of a cholesteric liquid-crystal layer and a λ/4 plate.

11. The liquid-crystal display device of claim 1, wherein the member of generating polarized light is an anisotropic multi-layer thin film that transmits one linearly polarized light having a first vibration direction and reflects another linearly polarized light having a vibration direction perpendicular to the first vibration direction.

12. The liquid-crystal display device of claim 1, wherein the member of generating polarized light is an anisotropic scattering polarizing element.

13. The liquid-crystal display device of claim 1, comprising a backlight on an outer side than the member of generating polarized light.
